(19) United States
(12) Patent Application Publication
(10) Pub. No.: US 2020/0302430 A1
(43) Pub. Date: Sep. 24, 2020

(54) Private Multi-Secret Cryptographic Transaction System

(71) Applicant: Allen Pulsifer, Annapolis, MD (US)

(72) Inventor: Allen Pulsifer, Annapolis, MD (US)

(21) Appl. No.: 16/809,144

(22) Filed: Mar. 4, 2020

Related U.S. Application Data
(60) Provisional application No. 62/813,183, filed on Mar. 4, 2019.

(51) Int. Cl. G06Q 20/36; H04L 9/32; G06Q 20/38; G06Q 20/40; G06Q 40/02

(52) U.S. Cl. CPC G06Q 20/3672; H04L 9/3218; G06Q 20/3674; G06Q 20/3678; G06Q 2220/00; G06Q 20/401; G06Q 40/02; H04L 2209/56; G06Q 20/38215

(57) ABSTRACT

This invention is in the field of private cryptographic transactions and discloses a method to create completely private escrow and swap transactions using a private or “zero knowledge” proving system.

### FIELD OF INVENTION

This invention discloses a method to add completely private “multi-signature” transactions, completely private escrow transactions and completely private swap transactions to a cryptographic transaction system.

### PRIOR ART

U.S. patent application Ser. No. 16/254,035 disclosed two embodiments of adding completely private “multi-signature” transactions to a cryptographic transaction system. In both embodiments, a token would be associated with more than one spend secret, as well as the number of valid spend secrets required for a transaction. The difference involved the construction of the transaction. In the first embodiment, all of the spend secrets for all of the input tokens would be provided to a single prover, who would then construct a zero knowledge proof using these secrets. In the second embodiment, the holder of each secret would construct a zero knowledge proof without sharing the secret. The advantages of the first embodiment are that it required less computation and required the transmission of only one proof, but the disadvantage is that the single prover gained knowledge of all of the spend secrets and could create a transaction that sent the input funds to any destination. The advantage of the second embodiment is the holder of each secret could provide a proof only if it approved of the destination of the funds, but the disadvantages are that it required more computation and required the transmission of multiple proofs. It is desired to have a method that, for certain applications, has the advantages of the first embodiment without its disadvantage.

One application of multi-secret transactions is a three-party escrow transaction involving a buyer, a seller, and an arbitrator, that works as follows:
1. The buyer places the escrow funds into a token with three spend secrets: a spend secret known only by the buyer, one known only by the seller, and one known only by the arbitrator. The token requires two of these three secrets in order to be spent.
2. If and when the buyer and seller both agree that the seller should have all of the funds that were placed in escrow, the buyer provides its spend secret to the seller, and the seller then creates a transaction using that secret and its own secret to send the escrow funds to itself
3. If and when the buyer and seller both agree that the buyer should be returned all of the funds placed in escrow, the seller provides its spend secret to the buyer, and the buyer then creates a transaction using that secret and its own secret to return the escrow funds to itself
4. If the buyer and seller both agree that seller should get part of the funds in escrow, and the buyer should get part back, this can be solved by creating a second escrow transaction. In this second escrow transaction, the seller would place the amount to be returned to the buyer into a second escrow token with three spend secrets: a new spend secret known by only by the buyer, a new spend secret or the prior spend secret known only by the seller, and a new spend secret or the prior spend secret known only by the arbitrator or by an alternate arbitrator. This second escrow token also requires two of these three secrets in order to be spent. The buyer provides its spend secret for the first escrow token to the seller, and the seller then creates a transaction using that secret and its own secret to send those escrow funds to itself. The seller then provides its spend secret for the second escrow token to the buyer, and the buyer then creates a transaction using that secret and its own secret to send those escrow funds to itself
5. If at any point the buyer and seller cannot agree or if one of them fails to perform, then using the first embodiment in U.S. patent application Ser. No. 16/254,035, either the buyer or seller or both can send their secret to the arbitrator, at which point the arbitrator can create one or more transaction to settle the escrow amount. As described above however, the arbitrator could also create a transaction that takes all the escrow funds for itself, which is the disadvantage of the prior art.

It is desired to have a method of implementing completely private escrow transactions that allows the buyer or seller to provide their secret to the arbitrator, allowing the arbitrator to settle the escrow funds by creating a transaction with a single proof, without allowing the arbitrator to take the escrow funds for itself.

Another use in the prior art for multi-signature transactions is a swap transaction (also known as an “atomic swap”). In a swap transaction, Party A sends asset X to Party B, and Party B sends asset Y to Party A. If asset X is sent on one blockchain, and asset B is sent on a different blockchain, this is called a “cross-chain swap” or “cross-chain atomic swap”. One requirement is that if either party does not receive the asset from the other, then that party must be able to reclaim the asset it sent. The end result is that either no assets are transferred, or both assets are transferred, but it cannot possible that one of the two parties can obtain the other's asset while preventing the other from obtaining its asset. Various protocols have been described to accomplish this. The easiest to understand uses what are called “hashlocked” transaction outputs, as follows:
1. Party A generates a private key PrivA, a corresponding public key PubA, and a hashlock secret H. Party A sends PubA and hash(H) to Party B.
2. Party B generates a private key PrivB, a corresponding public key PubB, and sends PubB to Party A.
3. Party A creates and submits the transaction A2B with one output that contains asset X and can be spent in two different ways:
   a. By signing a spend transaction with PrivB and providing a value H that corresponds to hash(H); or
   b. At time TA in the future, by signing a spend transaction with PrivA.
4. Party B verifies that transaction A2B comes from Party A and has the properties described above.
5. Party B creates and submits the transaction B2A with one output that contains asset Y and can be spent in two different ways:
   a. By signing a spend transaction with PrivA and publishing a value H that corresponds to hash(H); or
   b. At time TB in the future, where TB<TA, by signing a spend transaction with PrivB.
6. Party A verifies that transaction B2A comes from Party B and has the properties described above.
7. Party A confirms that time TB is sufficiently in the future that Party B cannot spend the output of B2A using PrivB before it can be claimed by Party A in the next step.
8. Party A creates and submits a transaction CA that sends the output of B2A to itself by signing CA with PrivA and publishing the value H.
9. Party B monitors the blockchain for a transaction spending the output of B2A, and when it sees transaction CA, it reads the value H from that transaction.
10. Party B creates and submits a transaction CB that sends the output of A2B to itself by signing CB with PrivB and providing the value H.

The end result is that Party B obtains asset X, and Party A obtains asset Y. If Party B does not create transaction B2A, then Party A can reclaim the output of A2B at time TA by signing a transaction with PrivA, and if Party A does not create a transaction that publishes H, then Party B can reclaim the output of B2A at time TB by signing a transaction with PrivB.

One disadvantage of the prior art is that the swap transactions are public, and the transaction containing asset X can be linked to the transaction containing asset Y. It is desired to have a means to create completely private swap transactions, where the contents of the transactions are completely private, and the two transactions cannot be publicly linked.

### SUMMARY OF THE INVENTION

In a typical escrow transaction, the only acceptable disposition of the escrow funds is to an address controlled by the seller, an address controlled by the buyer, or part to each address. Recognizing this, the present invention adds a set of new properties to each token:
restrict_addresses is a boolean value indicating whether the destination addresses should be restricted when the token is spent.
restricted_address[1], . . . , restricted_address[R], where R can be set to any value desired, is a list of R addresses to which the token or any part thereof may be sent if the value of restrict_addresses for the token equals 1.

When creating an escrow token, these values are set so that the escrow token can only be sent to an address controlled by the buyer, or an address controlled by the seller, or in part to each address. The arbitrator therefore can only send the escrow funds to the buyer or the seller, or it can split between the buyer and seller, but it cannot take the escrow funds for itself or send them to anyone else.

Swap transactions as described in the prior art require (a) a mechanism to spend a token that requires two secrets, one of which is publicly published with the spend transaction; or (b) a mechanism to spend a token after a time in the future using a third secret. This is implemented in the present invention by adding two new properties to each token:
require_public_hashkey is a boolean value indicating whether one of the spend secrets must be publicly published when the token is spent using its spend secrets.
trust_locktime is a value that indicates the point in time in the future after which the token may be spent using its trust secrets.

The swap transactions are then created that require two of two spend secrets, with the first being the hashkey and the second being the recipient's spend secret; or one of one trust secrets, which is the sender's reclaim secret, and with the trust_locktime set appropriately. In one of the two transactions, require_public_hashkey is set true so that the hashkey must be published and provided to the other party when that transaction is claimed, and in the other transaction, require_public_hashkey is set false so the hashkey does not have to be published to claim that transaction, which keeps the linkage between the two transactions private.

The present invention also removes the public inputs enforce spend secrets and enforce_trust_secrets of the prior invention, since those inputs would distinguish between a transaction that transfers an asset and a transaction the reclaims part of a swap. In the prior invention, enforce_trust_secrets was used to distinguish a token that could not immediately be spent, and the spending delay was enforced by the blockchain. In the present invention, the time delay required when a token is being spent using its trust secrets is privately enforced by using the token's trust_locktime as a hidden input to a zero knowledge proof.

### DESCRIPTION OF DRAWINGS

FIG. 1 depicts the possible hierarchy of multi-secrets, including the more privileged multi-secrets called spend secret's, and the less privileged multi-secrets called trust secret's. For purposes of illustration, the number of secrets is shown as three, although a particular instantiation may have more or fewer.

FIGS. 2 through 7 depict the statements enforced by the zero knowledge proofs. In these drawings, a thick-lined rectangle represents a publicly published input to the proof; a thick-lined diamond represents a private or hidden input to the proof; a thin-lined diamond represents a computed value; a thin-lined circle represents a computation or mathematical relationship, and a thick-lined circle represents a constraint that is enforced and proven by the proof FIG. 2 depicts part of the proof statements for each transaction output token. FIGS. 3, 4, 5 and 6 depict part of the proof statements for each transaction input token. FIG. 7 depicts the proof statements for each combination of input token and output token.

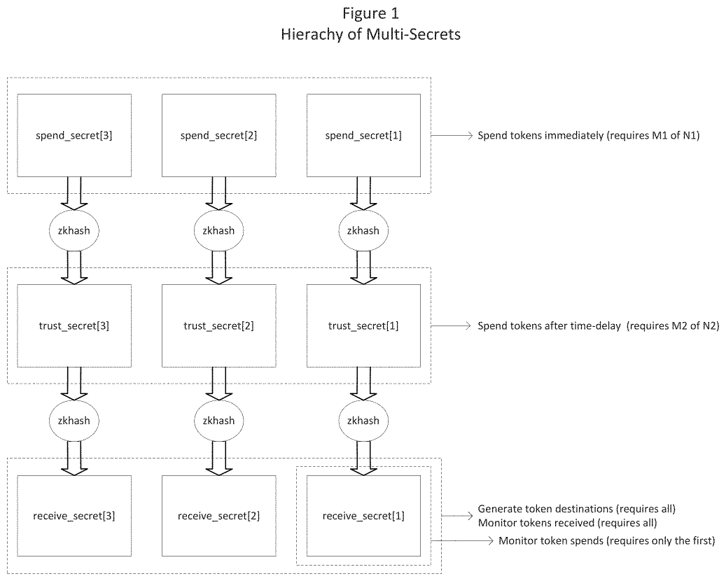

### DETAILED DESCRIPTION OF THE PREFERRED EMBODIMENTS

1. A zero knowledge proving system using Pinocchio or a similar system is set up to enforce the constraints given below for transactions with a multi-signature capacity (the maximum number of signatures desired for one token) of Q, with a maximum number of restricted addresses R, and with varying maximum numbers of input and output tokens, including a transaction with at least two input tokens and at least two output tokens, or alternately, a transaction with at least one input token and at least two output tokens and a transaction with at least two input tokens and at least one output token. In the preferred embodiment, it is desired that all transactions be indistinguishable, and therefore a zero knowledge proof would be set up for only one transaction type with two input tokens, two output tokens, the maximum allowed number of signatures Q, and the maximum number of restricted addresses R set equal to the maximum number of output tokens. As described in prior art, token value can be split and merged as desired by using a series of transactions each with two input tokens and two output tokens.

2. To initiate a transaction, the Payor determines the number of tokens she wishes to create as outputs of the transaction and the value of each token. The number of tokens created must be no more than the maximum number of output tokens allowed by the largest capacity zero knowledge proof One of the output tokens may be reserved to send “change” back to the Payor.

3. For each output token, the Payees or a designee chooses a boolean value for require_public_hashkey. If this value is true, spend_secret[2] must be publicly published when the token is spent.

4. For each output token, the Payee, or each of the parties that will participate in a multi-signature token (the Payees), generates one or more random or pseudo-random 256 bit spend_secret's. The spend_secrets may be derived from a master_secret and spend_secret_number as described in the '0673 application. The total number of spend_secrets N for an output token must be less than or equal to Q.

5. For each spend_secret, the respective Payee computes:
trust_secret=zkhash_C(spend_secret)
receive_secret=zkhash_D(trust_secret)

6. The Payees or a designee of the Payees organizes the receive_secret's into an array of N elements, receive_secret[1], . . . , receive_secret[N], where N can have a different value for each output token. If N for an output token is less than Q, the Payor adds to the array Q minus N additional receive_secret's, receive_secret[N+1], . . . , receive_secret[Q]. The additional receive_secret's may be known constants such as receive_secret=0 or receive_secret=zkhash_D(zkhash_C(0)). In the former form, it is assumed that a pre-hash of 0 (i.e., a value Z that satisfies zkhash_C(Z)=0) is unknown and can never be found; the safer and preferred embodiment however is to use receive_secret=zkhash_D(zkhash_C(0)), so that the pre-hashes of the additional receive_secret's are known by all parties.

7. For each receive_secret[i], the Payees or a designee choose boolean values for use_spend_secret[i]. If use_spend_secret[i]=0, the value of the corresponding spend_secret[i] will be ignored when the token is later spent, and will neither be enforced nor counted. If use_spend_secret[i]=1, the value of corresponding spend_secret[i] may be both enforced and counted when the token is spent. If require_public_hashkey=1, then use_spend_secret[2] must be set to 1. In the preferred embodiments, use_spend_secret[1] (the value corresponding to the first spend_secret) must always be 1, although it would be trivial to create an alternate embodiment that allowed use_spend_secret[1] to be 0 or 1. Note also in the preferred embodiments, the trust_secret's are always enforced regardless of the use_spend_secret values, although it again would be straightforward to create an alternate embodiment that included a corresponding array of use_trust_secret values that functioned like the use_spend_secret values. Note further that the array of use_spend_secret's may be eliminated with all values assumed to be 1, and the corresponding spend_secret's instead disabled by setting receive_secret[i] to a constant for which second pre-hashes (the spend_secrets) are not known. However, such an embodiment would make it more difficult to disable a spend_secret while enabling the corresponding trust_secret, since it would take an extra step to prove to the other parties that the receive_secret has no corresponding spend_secret. This extra step may be accomplished by setting trust_secret=zkhash_X(s) where zkhash_X uses different bases than zkhash_C and the value s is a secret value known only to the generating party, then creating and providing to the other parties a zero knowledge proof that receive_secret=zkhash_D(zkhash_X(s)) where s is a hidden input to the proof.

8. For each output token, the Payees or a designee determines values for required spend_secrets and required trust secrets. If N<Q and the additional receive_secret's were set to values with known pre-hashes such as receive_secret=zkhash_D(zkhash_C(0)), then required spend_secrets and required trust secrets should account for the additional spend_secret's and trust_secret's that are known by and can be input into a spend transaction by any party.

9. For each output token, the Payees or a designee chooses a 64-bit value for trust_locktime. This value is the unix time in seconds after which the token may be spent using its trust secrets.

10. For each output token, the Payees or a designee determines if the token should be restricted to a set of predetermined output addresses when spent. If so, the value restrict_addresses is set to 1; otherwise, the value restrict_addresses is set to 0. If restrict_addresses is set to 1, an array of values restricted_address[1], . . . , restricted_address[R] are each set to the value of one of the predetermined addresses. If the number of predetermined addresses is less than R, then one or more or the values of restricted_address are set to the same predetermined address value. Each predetermined address should appear at least once in the list of restricted_address[1], . . . , restricted_address[R], and may appear more than once.

11. The Payees or designee chooses a 28 bit destination_number and computes:
destination=zkhash_E(receive_secret[1], receive_secret[2], . . . , receive_secret[Q], use_spend_secret[2], . . . , use_spend_secret[Q], required_spend_secrets, required_trust_secrets, require_public_hashkey, trust_locktime, restrict_addresses, restricted_address[1], restricted_address[2], . . . , restricted_address[R], destination_number)

The destination_number may be a unique, sequential number for each combination of receive_secret's and restricted_addresses in order to produce a pseudo-random sequence of unique destination values.

12. The Payees or designee sends the destination value to the Payor using a secure (private and authenticated) channel.

13. For each output token, the Payor chooses an 18 bit payment_number, and computes:
address=zkhash_F(destination, payment_number)
amount enc=amount^{A} zkhash G(destination, payment_number)
commitment=zkhash H(destination, payment_number, amount)
   where \hat{ } is the bitwise exclusive-or operator. The payment_number may be a unique, sequential number for each destination, in order to produce a pseudo-random sequence of unique address values.

14. The Payor chooses a value for witness donation, which is an amount paid to the witness that incorporates this transaction into a block. If the donation is less than the suggested minimum, as determined by the witnesses, the transaction may not be incorporated by a witness into a block.

15. The Payor locates or creates one or more output tokens from a prior transaction or transactions to use as the input tokens for the current transaction. In this embodiment, in order to use a token as a transaction input, the Payor must know or obtain at least M1 of the token's spend_secrets where M1 is the required_spend_secrets value used when the token was created, or M2 of the token's trust secrets where M2 is the required_trust_secrets value used when the token was created. In order to obtain these secrets, the Payor may need to correspond with and negotiate with the holders of the other secrets, who may then use an encrypted channel to send the Payor one or more of the corresponding spend_secrets or trust secrets when they are satisfied that the Payor should have the authority to spend the token. If the Payor receives a spend_secret, it may compute the corresponding trust_secret=zkhash_C(spend_secret). To construct a valid transaction, the Payor must know or obtain the required secrets for input tokens with sufficient value in total to satisfy the equation:

sum(input token amounts)=>sum(output token amounts)+witness_donation

16. If sum(input token amounts)>sum(output token amounts), then the Payor creates an additional output token that represents the amount of “change” sent to herself or to one or more Payees. This output token uses one or more spend_secret's generated by or acceptable to the Payor, and the amount of this output token is chosen so that the following equation is satisfied:

sum(input token amounts)=sum(output token amounts)+witness_donation

17. For each input token, the Payor chooses boolean values for spend_secrets_valid and trust_secrets_valid. If the Payor knows at least M1 of the token's spend_secret values, the Payor may set spend_secrets_valid to 1, otherwise, the Payor must set this value to 0. If the Payor knows at least M2 of the token's trust_secret values and the current unix time is greater than the value of trust_locktime that was chosen when the token was created, then the Payor may set trust_secrets_valid to 1; otherwise, the Payor must set this value to 0. In order to use the token as a transaction input, either spend_secrets_valid or trust_secrets_valid associated with the token must be set to 1, or both must be set to 1.

18. For each i from 1 to Q of each input token, the Payor chooses a boolean value for secret valid[i]. If the Payor set spend_secrets_valid associated with the token to 1 and the Payor knows the spend_secret[i] that corresponds to the receive_secret[i] used when the token was created, then the Payor may set secret valid[i]=1, set spend_secret[i] to the known value, and compute and set trust_secret[i]=zkhash_C(spend_secret[i]); otherwise, the Payor must (with exceptions that are not useful in the preferred embodiment) set secret valid[i]=0. If spend_secrets_valid associated with an input token is 1, the transaction will only be valid (with exceptions that are not useful in the preferred embodiment) if at least M1 spend_secret value are set to correspond to their respective trust_secret values which in turn are set to correspond to their respective receive_secret values, and the respective secret valid values is set to 1, and the respective use_spend_secret value was set to 1 when the input token was created. Additionally, if spend_secrets_valid and require_public_hashkey associated with an input token are both 1, then the transaction will only be valid if secret valid[2] is set to 1. If the Payor set trust_secrets_valid associated with the token to 1 and the Payor knows the trust_secret[i] that corresponds to the receive_secret[i] used when a token was created, then the Payor may set secret valid[i]=1 and set trust_secret[i] to the known value; otherwise, the Payor must set secret valid[i]=0. If trust_secrets_valid associated with an input token is 1, the transaction will only be valid if at least M2 trust_secret values are set to correspond to their respective receive_secret values and the respective secret_valid values are set to 1.

19. For each input token, the Payor creates a two dimensional table of boolean values address_matches[i, j] where i goes from 1 to P where P is the number of output tokens in the transaction, and j goes from 1 to R. If the output address of the i'th output token equals restricted_address[j], then address_matches[i, j] is set to 1; otherwise, it is set to 0. If restrict_addresses for the input token was set to 1 when the token was created, then in order for the transaction to be valid, for each value of i, the above conditions must result in at least one of the values of address_matches[i, 1], address_matches[i, 2], . . . , address_matches[i, R] being set to 1.

20. For the transaction as a whole, if the donation is less than a threshold determined by the system rules, for example, less than 2 times the minimum acceptable donation, then the Payor sets allow restricted_addresses=1; otherwise, the Payor sets allow restricted_addresses=0. If restrict_addresses for any of the transaction input tokens was set to 1 when the token was created, then in order for the transaction to be valid, the above condition must result in allow restricted_addresses being set to 1. This prevents an input token for which restrict_addresses was set to 1 from being used in a transaction in which an excessive amount of the input funds is allocated to the witness_donation, instead of being sent to one of the restricted_addresses.

21. The Payor looks up the root hash of the Merkle tree containing all commitments in all indelible blocks in the blockchain as described in the '0673 application.

22. For each input token, the Payor looks up the token's commitment_number (its location in the Merkle tree) and the hash inputs along the path from the commitment to the Merkle root, as described in the '0673 application.

23. For each input token, the Payor computes
serial_number=zkhash_I(receive_secret[1], commitment, commitment_number)
   where receive_secret[1] is the value used when the input token was created.

24. For each input token, if require_public_hashkey was set to 1 when the token was created, the Payor sets hashkey for the token to equal to spend_secret[2]; otherwise, the Payor sets hashkey for the token to a random value in the same range as a spend_secret. In this way, every input token will include a published value for hashkey, even if that value is randomly chosen, to ensure that input tokens with require_public_hashkey=1 cannot be publicly distinguished from input tokens with require_public_hashkey=0.

25. For the transaction as a whole, the Payor sets transaction time to the current unix time.

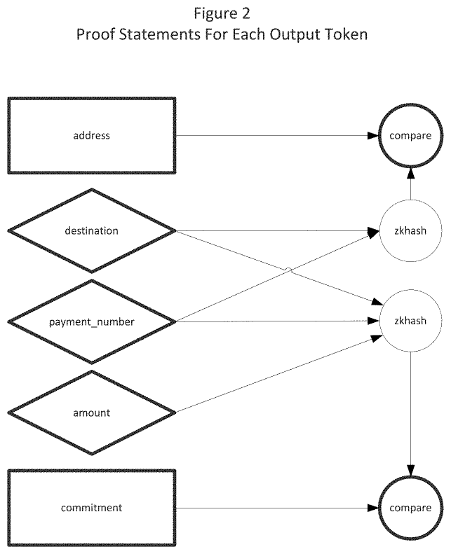

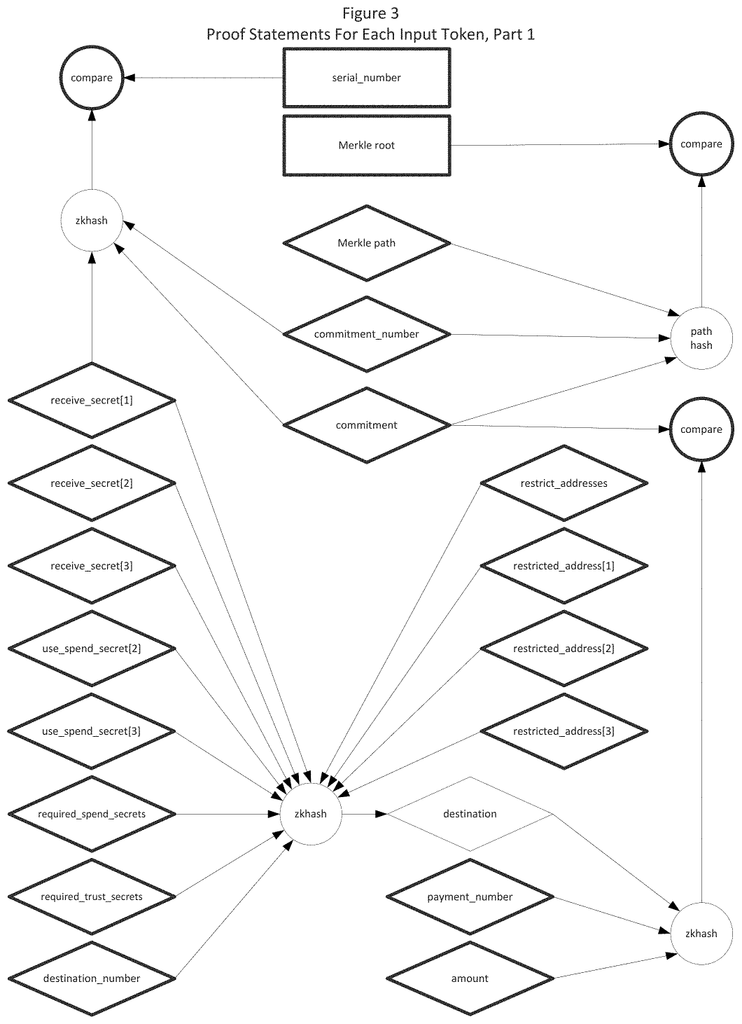

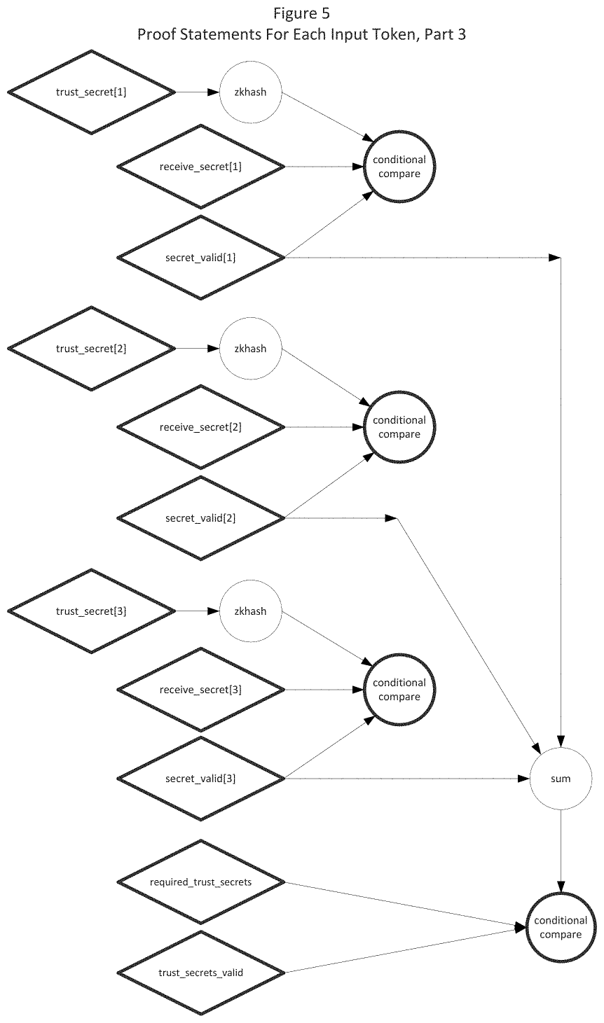

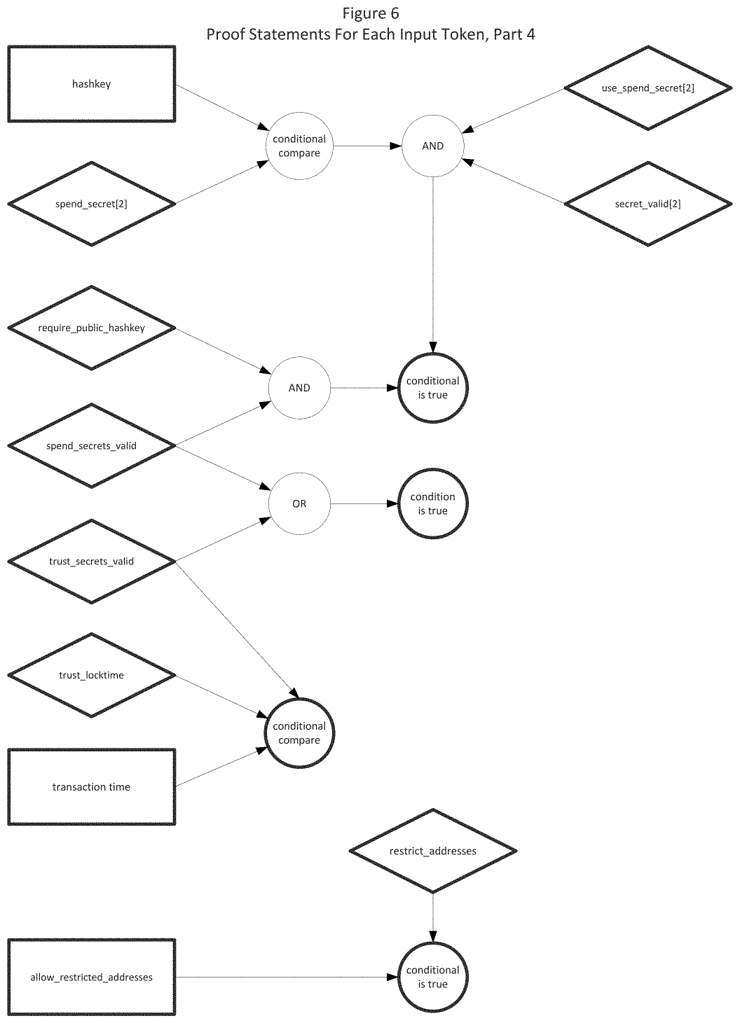

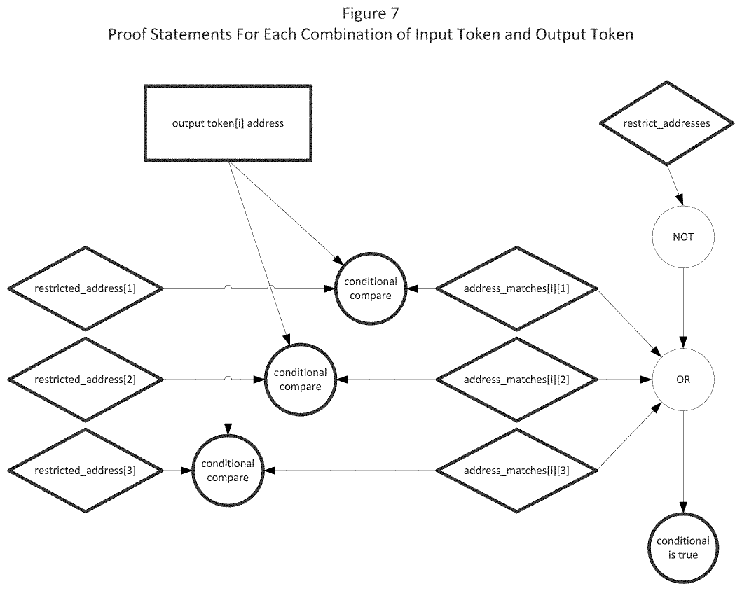

26. The Payor constructs a zero knowledge proof as follows (shown in part in FIGS. 2 through 7):
Public inputs for the entire transaction:
   # of input tokens
   # of output tokens
   Merkle root
   transaction_time
   allow restricted_addresses
   witness_donation
Public inputs for each input token:
   serial_number
   hashkey
Hidden inputs for each input token:
   spend_secrets_valid
   trust_secrets_valid
   for i from 1 to Q:
      receive_secret[i]
      spend_secret[i]
      trust_secret[i]
      secret_valid[i]
      use_spend_secret[i]
         where use_spend_secret[1]=1
   for i from 1 to R:
      restricted_address[i]
   for i from 1 to P and j from 1 to R:
      address_matches[i, j]
   required_spend_secrets
   required_trust_secrets
   require_public_hashkey
   trust_locktime
   restrict_addresses
   destination_number
   payment_number
   amount
   the commitment
   commitment_number
   the hash inputs along the tree path from commitment to Merkle root
Public inputs for each output token:
   address
   amount_enc
   commitment
Hidden inputs for each output token:
   destination
   payment_number
   amount

The zero knowledge proof proves the following constraints are satisfied:
For the transaction as a whole:
   all public input values used to create the proof are the same as the public input values used to verify the proof.

sum(input token amounts)=sum(output token amounts)+witness_donation
For each input token:

spend_secrets_valid is boolean
trust_secrets_valid is boolean
for each i from 1 to Q:

secret_valid[i] is boolean
use_spend_secret[i] is boolean
spend_secrets_valid * use_spend_secret[i] * secret_valid[i] *

(trust_secret[i] − zkhash_C(spend_secret[i])) = 0

where use_spend_secret[1] = 1

secret_valid[i] * (receive_secret[i] − zkhash_D(trust_secret[i])) = 0

use_spend_secret[1] * secret_valid[1] + ... +

use_spend_secret[Q] * secret_valid[Q] >= spend_secrets_valid *

required_spend_secrets

where use_spend_secret[1] = 1
[Note: the left side of this constraint can also be multiplied

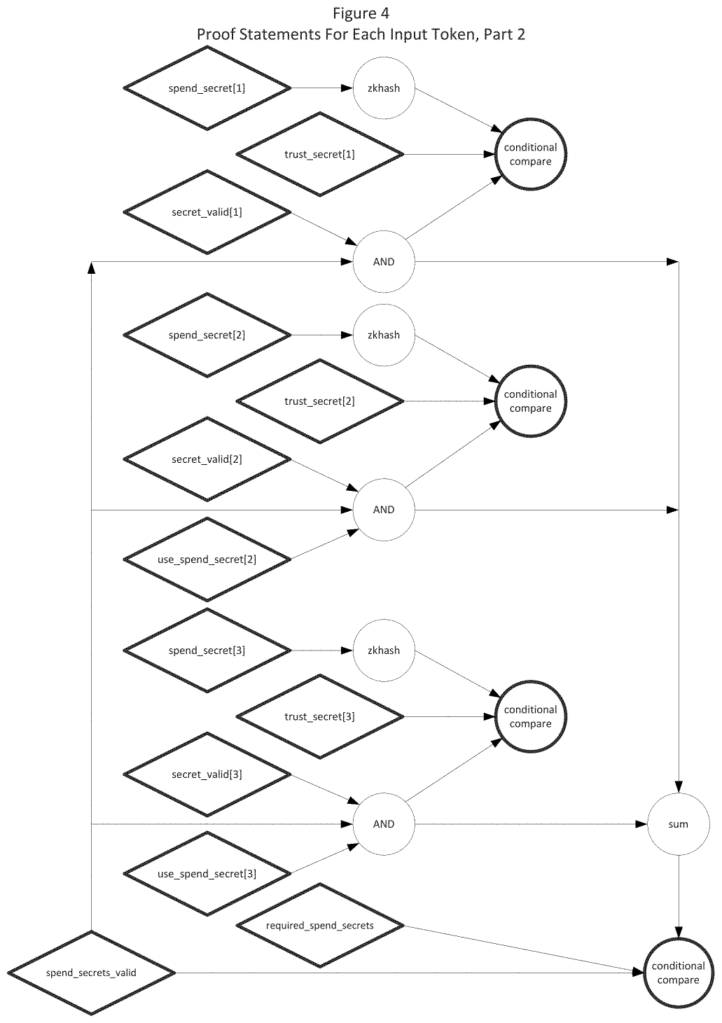

(AND'ed) with spend_secrets_valid, which gives an
equivalent constraint since spend_secrets_valid must be
boolean. This is the form shown in FIG. 4.]

secret_valid[1] + ... + secret_valid[Q] >= trust_secrets_valid *

required_trust_secrets

(1 − spend_secrets_valid) * (1 − trust_secrets_valid) = 0
require_public_hashkey is boolean
if spend_secrets_valid = 1 and require_public_hashkey = 1, then hashkey =

spend_secret[2] and use_spend_secret[2] = 1 and secret_valid[2] = 1

if trust_secrets_valid = 1, then trust_locktime < transaction_time
restrict_addresses is boolean
if restrict_addresses = 1, then allow_restricted_addresses = 1
for each i from 1 to P and each j from 1 to R:

address_matches[i, j] is boolean
if address_matches[i, j] = 1, then the address of

the i'th transaction output = restricted_address[j]

for each i from 1 to P:

if restrict_addresses = 1, then at least one of the address_matches[i, j]

values = 1, i.e. (1 − restrict_addresses) | address_matches[i, 1]|

address_matches[i, 2] | ... | address_matches[i, R] = 1

commitment = zkhash_H(destination, payment_number, amount)

where destination = zkhash_E(receive_secret[1], receive_secret[2], ...,

receive_secret[Q], use_spend_secret[2], ..., use_spend_secret[Q],
required_spend_secrets, required_trust_secrets,
require_public_hashkey, trust_locktime, restrict_addresses,
restricted_address[1],restricted_address[2], ...,
restricted_address[R], destination_number)

the commitment, commitment_number and Merkle path hash to the Merkle root
serial_number = zkhash_I(receive_secret[1], commitment, commitment_number)

For each output token:
   address=zkhash_F(destination, payment_number)
   amount_enc=amount\hat{ }zkhash_G(destination, payment_number)
   commitment=zkhash_H(destination, payment_number, amount)

Constraints for input and output tokens that are allowed by the capacity of the proving key but not used in the transaction are not enforced, i.e., each constraint is multiplied by a conditional variable that reflects whether the input or output token was used in the transaction.

The secret_valid values that the Payor uses in the zero knowledge proof ensure that she knows the required number of spend_secrets or trust_secrets that correspond to the receive secrets used when each token was created, and the use of spend_secrets_valid and trust_secrets_valid allows the Payor to know either the required number of spend_secrets or the required number of trust_secrets for each input token when transaction_time is greater than the input token's trust_locktime.

27. The Payor constructs a transaction in which are published the public inputs to the zero knowledge proof, the ID of the key used to construct the zero knowledge proof, and the zero knowledge proof itself.

28. The Payor broadcasts the transaction to the network.

29. Every network node that receives the transaction checks that:
The proof key ID is valid.
The capacity of the proving key is sufficient for the number of transaction input and output tokens.
The value of transaction_time is less than or equal to the current unix time.
The value of allow_restricted_addresses is boolean, and if it equals 1, then witness_donation is less than the value determined by the system rules.
The zero knowledge proof verifies using the public inputs published in the transaction.
The Merkle root published in the transaction is a valid value for the tree of all commitments.
No serial_number published for a transaction input token has been used as a prior input for this transaction or an earlier transaction in a block that contains this transaction or any block prior to the extent the serial numbers in that block have not expired.

30. If the transaction fails any of these tests, it is discarded. If it passes, the network node considers it to be valid. If the network node is a witness, the witness may place the transaction into a new block, as long as the transaction continues to be valid with respect to all prior transactions in the same block and all prior blocks. The witness adds the current unix time to the block, so other nodes to verify that the transaction times were checked with respect to the then current time, as described above. The witness may then broadcast the new block across the network.

31. The effect of a valid transaction would be to transfer the input token value to the output tokens. In that respect, the present invention functions nearly identically to the system disclosed in the '0673 application, and the input token serial numbers may be entered into a list of spent serial numbers and the output token commitments added to the Merkle tree of valid commitments when the block containing the transaction becomes indelible.

32. As described in the '0673 application, the Payor may notify the Payee of payments sent, or the Payee may detect incoming payments by monitoring the addresses associated with the destination values generated by the Payee, and then retrieve the incoming token's properties such as the token's commitment value and amount from the blockchain.

33. If desired, the current invention may also be used in conjunction with the other features of the '0673 application, such as enforce master secrets, commitments_published, outvals_public, nonfinancial, no_serialnum. The features of monitor_secret may also be implemented by including it in the first set of secrets, so that monitor_secret=zkhash(trust_secret[1]) and receive_secret[1]=zkhash(monitor_secret).

When the above invention is used for a three party escrow transaction, the buyer can first place the escrow funds into a token with restrict_addresses=1 and set restricted_address[1] for the token to an address generated by and controlled by the buyer, and set restricted_address[2] for the token to an address provided by the seller, and if R>2, would set the remaining restricted_address values to either address. The rest of the protocol would operate as described above.

The above invention can be used for an atomic swap as follows:
1. Party A generates a secret SSA, a secret TRA and a hashlock secret SSH. Party A sends TSA=zkhash_C(SSA), RRA=zkhash_D(TRA) and TSH=zkhash_C(SSH) to Party B.
2. Party B generates a secret SSB and a secret TRB. Party B sends TSB=zkhash_C(SSB) and RRA=zkhash_D(TRB) to Party A.
3. Party A creates and submits a transaction A2B with one output and:
   amount X
   use_spend_secret[1,2]=1; use_spend_secret[3, . . . ]=0
   trust_secret[1,2]=TSB, TSH
   receive_secret[3]=RRA
   required_spend_secrets=2; required_trust_secrets=3
   require_public_hashkey=0
   trust_locktime=TA
4. Party B verifies that transaction A2B comes from Party A and has the properties described above.
5. Party B creates and submits the transaction B2A with one output and:
   amount Y
   use_spend_secret[1,2]=1; use_spend_secret[3, . . . ]=0
   trust_secret[1,2]=TSA, TSH
   receive_secret[3]=RRB
   required_spend_secrets=2; required_trust_secrets=3
   require_public_hashkey=1
   trust_locktime=TB, where TB<TA
6. Party A verifies that transaction B2A comes from Party B and has the properties described above.
7. Party A confirms that time TB is sufficiently in the future that Party B cannot spend the output of B2A using its trust_secrets before it can be claimed by Party A in the next step.
8. Party A creates and submits a transaction CA that sends the output of B2A to itself by creating a zero knowledge proof using SSA and SSH and publishing the value SSH.
9. Party B monitors the blockchain for a transaction spending the serial_number of the output of B2A, and when it sees transaction CA, it reads the value SSH from that transaction.
10. Party B creates and submits a transaction CB that sends the output of A2B to itself by creating a zero knowledge proof using SSB and SSH.
11. If Party B does not create transaction B2A, then Party A can create a transaction at time TA that sends the output of A2B to itself by creating a zero knowledge proof using TSB, TSH and TRA.
12. If Party A does not create a transaction that publishes SSH, then Party B can create a transaction at time TB that sends the output of B2A to itself by creating a zero knowledge proof using TSA, TSH and TRB.

### SCOPE OF INVENTION

While the present invention has been described with reference to exemplary embodiments, it will be understood by those of ordinary skill in the art that various changes may be made and equivalents may be substituted for elements thereof without departing from the scope of the invention. In addition, many modifications may be made to adapt a particular application to the teachings of the invention without departing from the scope thereof. Therefore, it is intended that the invention not be limited to the particular embodiments disclosed, but that the invention will include all embodiments falling within the scope of the allowed claims.

What is claimed is:

1. A method of constructing a digital token used in a cryptographic transaction in which said token has one or more properties restricted_addresses[1], . . . , restricted_addresses[R] and where the use of said token as a transaction input is valid only if the address of each transaction output matches at least one of said restricted_addresses.

2. A method of claim 1 where a zero knowledge proof is used to prove that the use of said token as a transaction input is valid while keeping private said restricted_addresses properties.

3. A method of claim 1 where said digital token further has a boolean property restrict_addresses and where, if restrict_addresses has a value of 0, then the use of said token as a transaction input is valid regardless whether the address of each transaction output matches at least one of said restricted_addresses or not.

4. A method of claim 3 where a zero knowledge proof is used to prove that the use of said token as a transaction input is valid while keeping private said restrict_addresses and restricted_addresses properties.

5. A method of claim 3 where said cryptographic transaction has a boolean property allow_restricted_addresses which is set to 0 when the fee or donation associated with said transaction exceeds an acceptable value, and when so set, said transaction is invalid if said restrict_addresses property is 1 for any transaction input token.

6. A method of claim 5 where a zero knowledge proof is used to prove that the use of said token as a transaction input is valid while keeping private said restrict_addresses and restricted_addresses properties.

7. A method of claim 1 where said cryptographic transaction is an escrow transaction, said token has at least two restricted_addresses, at least one of said restricted_addresses is set to an address controlled by a transaction payor, and at least one of said restricted_addresses is set to an address controlled by a transaction payee.

8. A method of claim 2 where said cryptographic transaction is an escrow transaction, said token has at least two restricted_addresses, at least one of said restricted_addresses is set to an address controlled by a transaction payor, and at least one of said restricted_addresses is set to an address controlled by a transaction payee.

9. A method of claim 3 where said cryptographic transaction is an escrow transaction, said token has at least two restricted_addresses, at least one of said restricted_addresses is set to an address controlled by a transaction payor, and at least one of said restricted_addresses is set to an address controlled by a transaction payee.

10. A method of claim 4 where said cryptographic transaction is an escrow transaction, said token has at least two restricted_addresses, at least one of said restricted_addresses is set to an address controlled by a transaction payor, and at least one of said restricted_addresses is set to an address controlled by a transaction payee.

11. A method of claim 5 where said cryptographic transaction is an escrow transaction, said token has at least two restricted_addresses, at least one of said restricted_addresses is set to an address controlled by a transaction payor, and at least one of said restricted_addresses is set to an address controlled by a transaction payee.

12. A method of claim 6 where said cryptographic transaction is an escrow transaction, said token has at least two restricted_addresses, at least one of said restricted_addresses is set to an address controlled by a transaction payor, and at least one of said restricted_addresses is set to an address controlled by a transaction payee.

13. A method of constructing a digital token used in a cryptographic transaction in which said token is associated with one or more secret values which are required to use said token as a transaction input, and where said token has a boolen property require_public_hashkey which when set to 1, the use of said token as a transaction input is valid only if one or more of said secret values are published.

14. A method of claim 13 where a zero knowledge proof is used to keep said require_public_hashkey property private while proving that said published values are said secret values associated with said token.

15. A method of claim 14 where said cryptographic transaction is a swap transaction.

16. A method of constructing a digital token used in a cryptographic transaction in which said token has one or more sets of one or more secret values, and where at least one of said sets is required to use said token as a transaction input, and where one of said sets if used in a transaction is only valid after a passage of time which may be defined as an absolute time or of a block level in a blockchain or some other value related to the passage of time, and where a zero knowledge proof is used to keep private said requirement of the passage of time while proving that said passage of time requirement has been satisfied.

17. A method of claim 16 where said cryptographic transaction is a swap transaction.
